(19) United States
(12) Patent Application Publication
(10) Pub. No.: US 2018/0160069 A1
(43) Pub. Date: Jun. 7, 2018

(54) METHOD AND SYSTEM TO TEMPORARILY DISPLAY CLOSED CAPTION TEXT FOR RECENTLY SPOKEN DIALOGUE

(71) Applicant: ARRIS Enterprises LLC, Suwanee, GA (US)

(72) Inventor: Carl A. Burger, Hatboro, PA (US)

(21) Appl. No.: 15/366,077

(22) Filed: Dec. 1, 2016

(51) Int. Cl. H04N 5/445; H04N 7/088; H04N 5/44

(52) U.S. Cl. CPC H04N 5/44582; H04N 5/4403; H04N 7/0882

(57) ABSTRACT

A method, system and computer readable media temporarily display closed captions. An equipment device (e.g., set top box, smart TV or other display device) receives a source signal that includes at least a video signal and a plurality of closed caption entries. Each closed caption entry is associated with a portion of the video signal. The equipment device stores in a memory the plurality of closed caption entries and displays, on a display device interfaced with the equipment device, the video signal. The equipment device also displays, on the display device, a least one prior closed caption entry of the plurality of closed caption entries stored in the memory where the associated portion of the video signal was previously displayed on the display device, wherein the prior closed caption entry is displayed without interrupting display of the video signal.

### FIELD

The present disclosure relates to the temporary display of closed captions, specifically the technological improvement of display equipment to enable the temporary display of previously displayed closed caption text and subtitles without interruption of the corresponding video signal.

### BACKGROUND

Closed captions and subtitles have revolutionized television, movies, and other visual media by enabling much broader accessibility, allowing individuals to enjoy media that may be produced in a foreign language, to allow for individuals to enjoy media when the accompanying audio may be unavailable, and to provide captions for dialogue and other descriptive text for the hearing impaired. Traditionally, closed caption text accompanies a video signal in a source signal that is transmitted out over the air, transmitted through coaxial cables, read though magnetic tape, etc., where text is displayed concurrently with a portion of the video signal (e.g., where the text corresponds to dialogue spoken in the video signal).

As a result, if the viewer misses a line of closed caption text or a subtitle, the viewer may be unable to access the text again without navigating to an earlier point in the accompanying video signal. In many cases, televisions, set top boxes, and other video display equipment may lack the ability to record displayed visual media for such navigation. In addition, such an ability may also be impossible or impractical for video that is being displayed live, such as with live news and sports broadcasts. In these instances, the viewer may be unable to navigate to an earlier point in the video signal to review a missed line of closed caption text or a subtitle. Furthermore, there may be some instances where a viewer may want to review a missed line without interrupting the video signal.

Thus, there is a need of a technological solution to enable video display equipment to provide the capability for the temporary display of previously displayed closed caption text to a viewer without interruption of the accompanying video signal, to provide for access to prior closed caption text without the need to record a broadcast or navigate to an earlier point in the video signal.

### SUMMARY

The present disclosure provides a description of systems and methods for temporary display of closed captions. By enabling a viewer to navigate to earlier closed caption texts that were displayed without interrupting the video signal, the viewer may continue to enjoy a live broadcast while catching up on a missed caption or subtitle, and may also be able to effectively “rewind” the closed caption text for a show, movie, or other visual media even in instances where the video display equipment may lack the storage space and technology necessary to record the accompanying video signal, particularly in instances where high definition or ultra high definition video signals are used. As such, the methods and systems discussed herein can provide for a useful technological advancement to video display equipment that expands on the accessibility and convenience provided to viewers of visual media.

A method for temporary display of closed captions includes: receiving, by an equipment device, a source signal that includes at least a video signal and a plurality of closed caption entries, wherein each closed caption entry is associated with a portion of the video signal; storing, in a memory of the equipment device, the plurality of closed caption entries; displaying, on a display device interfaced with the equipment device, the video signal; and displaying, on the display device, a least one prior closed caption entry of the plurality of closed caption entries stored in the memory where the associated portion of the video signal was previously displayed on the display device, wherein the prior closed caption entry is displayed without interrupting display of the video signal.

An apparatus for temporary display of closed captions includes: a communications interface of an equipment device configured to receive a source signal that includes at least a video signal and a plurality of closed caption entries, wherein each closed caption entry is associated with a portion of the video signal; a memory of the equipment device configured to receive the plurality of closed caption entries; and a display device interfaced with the equipment device configured to display the video signal, and a least one prior closed caption entry of the plurality of closed caption entries stored in the memory where the associated portion of the video signal was previously displayed on the display device, wherein the prior closed caption entry is displayed without interrupting display of the video signal.

A non-transitory computer readable media has instructions operable to cause one or more processors to perform operations comprising: receiving, by an equipment device, a source signal that includes at least a video signal and a plurality of closed caption entries, wherein each closed caption entry is associated with a portion of the video signal; storing, in a memory of the equipment device, the plurality of closed caption entries; displaying, on a display device interfaced with the equipment device, the video signal; and displaying, on the display device, a least one prior closed caption entry of the plurality of closed caption entries stored in the memory where the associated portion of the video signal was previously displayed on the display device, wherein the prior closed caption entry is displayed without interrupting display of the video signal.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the temporary display of previously displayed closed caption text in accordance with exemplary embodiments.

FIG. 2 is a block diagram illustrating the equipment device of the system of FIG. 1 for the temporary display of closed caption text in accordance with exemplary embodiments.

FIG. 3 is a flow diagram illustrating a process for the temporary display of closed caption text using the equipment device of FIG. 2 in accordance with exemplary embodiments.

FIGS. 4A-4C are diagrams illustrating the storage and display of closed caption text using the equipment device of FIG. 2 in accordance with exemplary embodiments.

FIG. 5 is a flow chart illustrating an exemplary method for temporary display of closed captions in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Temporary Display of Closed Captions

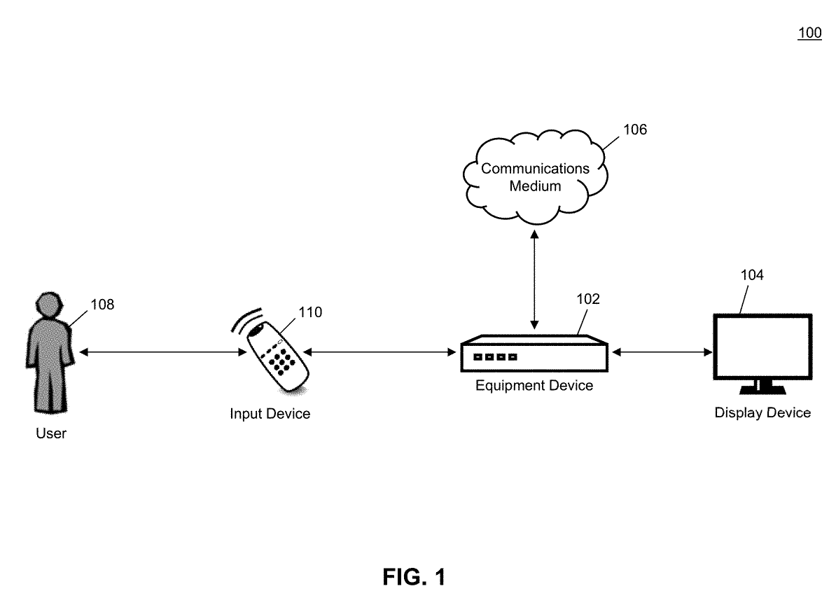

FIG. 1 illustrates a system 100 for the temporary display of closed caption text corresponding to previously displayed video without interruption of the accompanying video signal, effectively enabling a viewer to “rewind” the closed captions without pausing the accompanying video.

The system 100 may include an equipment device 102. The equipment device 102, discussed in more detail below, may be a computing device configured to receive source signals that are superimposed or otherwise encoded with a video signal and accompanying closed caption signal, which may be comprised of a plurality of closed caption entries. For instance, the equipment device 102 may be a television, smart television, set top box, receiver, desktop computer, laptop computer, notebook computer, tablet computer, cellular phone, smart phone, smart watch, etc. In some instances, the equipment device 102 may be interfaced with a display device 104 or other device that may display the video signal and closed caption entries received by the equipment device 102. For instance, the equipment device 102 may be a set top box connected to the display device 104, where the display device 104 may display the video signal and accompanying closed caption entries as received and instructed by the equipment device 102. The equipment device 102 and display device 104 may be interfaced through any suitable type of interface, such as coaxial cable, fiber optic cable, infrared transmission, a local area network, radio frequency, Bluetooth, etc. The equipment device 102 and display device 104 may be housed within a unitary housing, such as a television set, and hard wired and/or integrated together.

The equipment device 102 may receive a source signal that is electronically transmitted via a communications medium 106, such as over-the-air, over a cable connection (e.g., via HDMI cable, component cables, A/V (composite) cable, coaxial cable, fiber optic, or other suitable physical cable), via satellite, or other suitable communications medium. For example, the communications medium 106 may be broadcast television, a local area network, cellular communication network, or the Internet where the source signal may be streamed to the equipment device 102 using the communications medium 106. In some instances, the source signal may be received from media inserted into one or more suitable input devices of the equipment device 102. For example, the source signal may be read from a digital video disc (DVD) or a Blu-ray disc.

The source signal may be superimposed or otherwise encoded with at least a video signal and a closed caption signal, the closed caption signal being comprised of a plurality of closed caption entries. Each closed caption entry may be associated with a portion of the video signal, where, traditionally, the closed caption entry is displayed on the display device 104 at the same time as the associated portion of the video signal. In some instances, the source signal may include a plurality of closed caption signals, where each closed caption signal may have different properties, such as the language of the caption texts (e.g., where the language used may be specified by the viewer, a default language, etc.). As discussed herein, “closed captions” and closed caption text may also refer to subtitles, audio descriptions, descriptive video, or other types of captioning and subtitling that may accompany a video signal for display on a display device 104. Closed caption entries may be comprised of a plurality of text entries, images, or media in any other format that may be suitable for receipt and storage by the equipment device 102 and display on the equipment device 102 or an interfaced display device 104. In some embodiments, the formatting, transmission, and/or receipt of source signals that include closed captioning data may be subject to one or more standards, rules, or regulations, such as those set forth by the Federal Communications Commission, Consumer Electronics Association, Society of Cable Telecommunications Engineers, etc. In such embodiments, the equipment device 102 may be configured to operate in compliance with the standards, rules, and/or regulations set forth by the appropriate entity or entities.

The equipment device 102 may receive the source signal and may display the video signal and any associated closed caption entries on the interfaced display device 104. At some point during the display of the video signal, a user 108 of the equipment device 102 may desire to review a previously displayed or otherwise missed closed caption entry. The user 108 may, using an input device 110, submit an instruction to the equipment device 102 to temporarily display a closed caption entry corresponding to a previously displayed portion of the video signal, without interrupting the video signal. The input device 110 may be a remote control, mobile computing device (e.g., a tablet computer, cellular phone, smart phone, etc.), camera, microphone, or other suitable input device that may be interfaced with the equipment device 102 to provide user accessibility and input of user instructions.

The equipment device 102 may be configured to store a buffer of the closed caption entries that accompany the video signal being displayed on the display device 104. In some instances, the size of the buffer may be limited, such that only a predetermined amount of closed caption entries may be stored therein. For example, the equipment device 102 may store a predetermined number of closed caption lines or images, the closed caption lines or images corresponding to a predetermined length of time (e.g., three minutes of the accompanying video signal), or closed caption lines or images up to a predetermined amount of memory (e.g., 64 megabytes of closed caption lines or images). The buffer may be operated as a “first in, first out” buffer, such that each time a new closed caption entry is stored into the buffer, the earliest entry that had been added to the buffer is removed. Of course, other memory formats than a buffer may be used as an alternative or in combination with a buffer memory, such as random access memory with memory management to access to the recently played portions (particularly in situations such as playback of stored content) and possibly to remove closed captioning that is not likely to be accessed. For simplicity, buffer memory will be referenced to include all possibilities herein.

The equipment device 102 may receive the instruction submitted by the user 108 to view an earlier closed caption entry. The equipment device 102 may access the buffer stored therein and access an earlier closed caption entry, which may then be displayed on the display device 104 without interrupting the video signal, such that the earlier closed caption entry is being displayed during a different portion of the video signal than its associated portion. In some embodiments, the equipment device 102 may first display the most recently added closed caption entry (e.g., the closed caption entry corresponding to the most recently displayed portion of the video signal), optionally with an indication of when in the past the words were spoken (e.g., (“5 seconds ago”, “10 seconds ago”, or a thumbnail of an image of the scene when the words were spoken, etc.). In such embodiments, the user 108 may continue to submit instructions to navigate to earlier closed caption entries, where the equipment device 108 may cycle through earlier and earlier closed caption entries based on when they were added to the buffer. This may enable the user 108 to effectively “scroll” through earlier closed caption entries until they are satisfied, which may be accomplished by providing a rolling scroll through the preceding captions until stopped by the user 108.

In some instances, the equipment device 102 may pause updating of the buffer during access of the earlier closed caption entries. In other instances, the equipment device 102 may continue to update the buffer, such that, if the user 108 has navigated to the earliest closed caption entry in the buffer, the user 108 may be prevented from going back further and may have the currently accessed closed caption entry removed during viewing. In some cases, the equipment device 102 may have a secondary buffer, for storage of closed caption entries for addition to the primary buffer during pausing of the buffer when being accessed by the user 108.

In some cases, the display device 104 may not be displaying closed captions when the user 108 submits an instruction to the equipment device 102 to display an earlier closed caption entry. For example, the user 108 may be watching the visual media and following the audio without need for closed captioning, but may miss a word or line and want to review what was missed, without interrupting the video signal. In such cases, the equipment device 102 may be configured to activate the closed captioning display of the display device 104 as part of the identification and display of the earlier closed caption entries. In these cases, the equipment device 102 may be configured to deactivate the closed captioning display of the display device 104 once the display of earlier closed caption entries has ceased. The ceasing of the display of earlier closed caption entries may occur based on user instruction (e.g., the user 108 may indicate that they are satisfied via the input of an instruction via the input device 110, which may prompt the removal of the earlier closed caption entry from the display device 104), timeout (e.g., the earlier closed caption entry may be removed from the display device 104 after no instruction has been submitted by the user 108 for a predetermined period of time), or other suitable criteria.

In some instances, the display device 104 may have the display of closed captions active when the user 108 requests the display of a prior closed caption entry. In such instances, the earlier closed caption entry may replace the active closed caption entry (e.g., the closed caption entry associated with the video signal currently being displayed), or may be displayed in addition to the active closed caption entry. In former instances, the prior closed caption entry may displayed, and, once the display has ceased, the closed caption entry associated with the portion of the video signal that is being displayed at that time may be displayed. In such instances, one or more closed caption entries may be missed (e.g., as would have been displayed during the time the user 108 is reviewing the earlier closed caption texts). In such cases, the equipment device 102 may continue to add the closed caption entries to the buffer, and may enable the user 108 to navigate forward through the closed caption entries from the currently displayed entry. In these cases, the user 108 may navigate to the earlier entry they want to review, and then may navigate forward and review any more recent entries and catch up to the active closed caption entry. In some such cases, once the user 108 has triggered display of the active closed caption entry, the equipment device 102 and/or display device 104 may return to normal display of closed caption entries, effectively ceasing the access of the prior closed caption entries.

In instances where earlier closed caption entries may be displayed concurrently with the active closed caption entry, the earlier closed caption entries may be distinguished from the active closed caption entry. For example, the earlier closed caption entries may be displayed in a different location on the display device 104 or may be provided with different display settings, such as a different font face, font size, font color, font weight, font style, font effect, etc. For instance, in an example, the active closed caption entry may be displayed near the bottom of the display device 104 as white text on a black background, and the earlier closed caption entries may be displayed near the top of the display device as smaller, italicized white text on a gray background. In such instances, the equipment device 102 may be configured to enable the user 108 to customize the display settings of the earlier closed caption texts. In some such instances, the customization may include if the earlier closed caption entries are to be displayed concurrently with or replace the active closed caption entry, and the criteria for ceasing of the display of the earlier closed caption entries.

In some embodiments, timestamp information may be displayed with the earlier closed caption entries. For instance, each closed caption entry may further include a timestamp corresponding to the associated portion of the video signal. In such an instance, the timestamp may be displayed with the earlier closed caption entry, such as to indicate the time at which the corresponding closed caption is associated. In some such instances, the timestamp may be represented as a difference in time from the timestamp and the portion of the video signal being currently displayed. For example, the earlier closed caption entry may include “[−0:18]” in or with the displayed text or image to indicate that the corresponding entry is associated with the portion of the video signal displayed eighteen seconds prior to the portion currently displayed on the display device 104. In some cases, additional information may be used to indicate the portion of the video signal to the user 108, such as a thumbnail image of the associated portion of the video signal.

The methods and systems discussed herein may thus enable a user 108 that is viewing visual media to review closed caption entries associated with previously viewed portions of a video signal without interrupting the display of the video signal. As a result, the user 108 may review earlier closed caption entries in cases where the equipment device 102 and/or display device 104 lacks the storage or ability to record, pause, and/or rewind visual media, or in cases where the user 108 does not want to interrupt the video signal but still review earlier captions, such as for a live sports broadcast where the user 108 may miss a statistic or news item they want to review, but not miss the ongoing action. Thus, the methods and systems discussed herein provide for a technological improvement over existing visual display devices and equipment that provides for greater user control over the display of captions with visual media, and for additional accessibility for hearing impaired individuals.

### Equipment Device

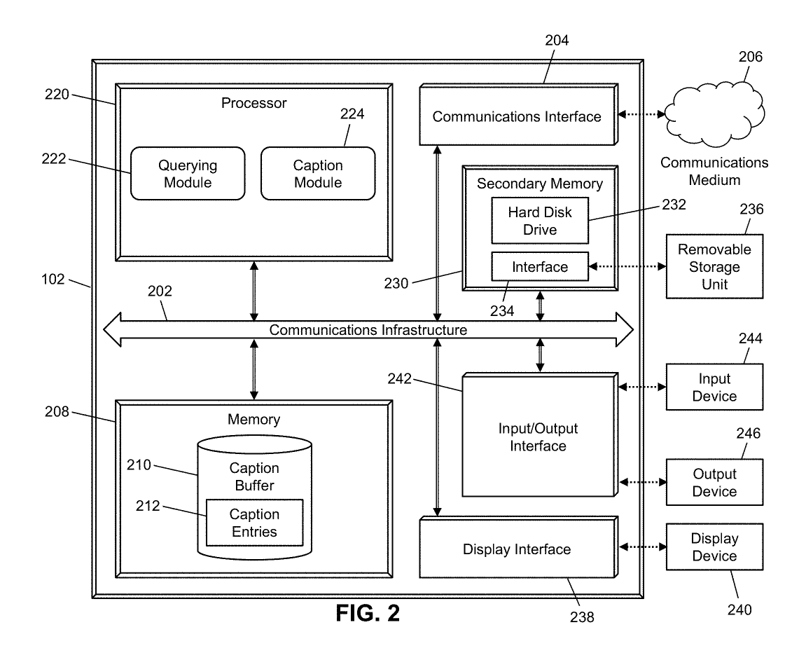

FIG. 2 illustrates an embodiment of the equipment device 102 in the system 100. It will be apparent to persons having skill in the relevant art that the embodiment of the equipment device 102 illustrated in FIG. 2 is provided as illustration only and may not be exhaustive to all possible configurations of the equipment device 102 suitable for performing the functions as discussed herein.

The equipment device 102 may include a communications infrastructure 202. The communications infrastructure 202 may be configured to transmit data between modules, engines, databases, memories, and other components of the equipment device 102 for use in performing the functions discussed herein. The communications infrastructure 202 may be comprised of one or more communication types and utilize various communication methods for communications within a computing device. For example, the communications infrastructure 202 may be comprised of a bus, contact pin connectors, wires, etc. In some embodiments, the communications infrastructure 202 may also be configured to communicate between internal components of the equipment device 102 and external components of the equipment device 102, such as externally connected databases, display devices, input devices, etc.

The equipment device 102 may also include a communications interface 204. The communications interface 204 may include one or more interfaces used to interact with and facilitate communications between the equipment device 102 and one or more external devices via suitable communications mediums 204. For instance, the communications interface 204 may interface with the communications infrastructure 202 and provide an interface 204 for connecting the equipment device 102 to one or more communications mediums 204 for the electronic transmission or receipt of data signals that are encoded or otherwise superimposed with data for use in performing the functions discussed herein. Communications interfaces 204 may include universal serial bus (USB) ports, Personal Computer Memory Card International Association (PCMCIA) ports, PS/2 ports, serial ports, fiber optic ports, coaxial ports, twisted-pair cable ports, wireless receivers, etc. Communications mediums 206 may include local area networks, wireless area networks, cellular communication networks, cable television networks, satellite television networks, the Internet, radio frequency, Bluetooth, near field communication, etc.

In some instances, the equipment device 102 may include multiple communications interfaces 204 for electronically transmitting and receiving data signals via one or more communications mediums 206, such as a first communications interface 204 configured to transmit and receive data signals via a local area network and a second communications interface 204 configured to transmit and receive data signals via the Internet. In some instances, the communications interface 204 may include a parsing module for parsing received data signals to obtain the data superimposed or otherwise encoded thereon. For example, the communications interface 204 may include (e.g., or otherwise have access to, such as via the communications infrastructure 202) a parser program configured to receive and transform the received data signal into usable input for the functions performed by the processing device to carry out the methods and systems described herein.

The communications interface 204 may be configured to receive data signals electronically transmitted through a communications medium 106, such as from an internet service provider, cable television provider, satellite television provider, etc., which may be superimposed or otherwise encoded with source signals that are comprised of video and closed captioning signals. In some instances, a source signal may include a plurality of closed captioning signals, such as closed captioning signals for each of a plurality of different languages, and may also include one or more audio signals.

The equipment device 102 may also include a memory 208. The memory 208 may be configured to store data for use by the equipment device 102 in perform the functions discussed herein. The memory 208 may be comprised of one or more types of memory using one or more suitable types of memory storage, such as random access memory, read-only memory, hard disk drives, solid state drives, magnetic tape storage, etc. The memory 208 may store data in any suitable type of configuration, such as in one or more lists, databases, tables, etc., which may store the data in a suitable data format and schema. In some instances, the memory 208 may include one or more relational databases, which may utilize structured query language for the storage, identification, modifying, updating, accessing, etc. of structured data sets stored therein.

The memory 208 of the equipment device 102 may include a caption buffer 210. The caption buffer 210 may be configured to store a plurality of caption entries 212 using a suitable storage format and schema. Each caption entry 212 may be a closed caption entry associated with a previously displayed (e.g., or previously transmitted, such as to the display device 104) portion of the video signal. Each closed caption entry 212 may be a text field, image file, or other suitable file format. In some embodiments, the caption entries 212 may be stored in the caption buffer 210 using a first in, first out methodology, such that, when the caption buffer 210 is at capacity, each time a new caption entry 212 is inserted into the caption buffer 210, the earliest added caption entry 212 currently in the caption buffer 210 is removed. Capacity of the caption buffer 210 may be determined by the number of caption entries 212, file size of the caption entries 212, a total portion of time of the video signal associated with each of the caption entries 212, etc.

The equipment device 102 may also include a processor 220. The processor 220 may be configured to perform the functions of the equipment device 102 discussed herein as will be apparent to persons having skill in the relevant art. In some embodiments, the processor 220 may include and/or be comprised of a plurality of engines and/or modules specially configured to perform one or more functions of the processing device, such as a querying module 222, caption module 224, etc. As used herein, the term “module” may be software or hardware particularly programmed to receive an input, perform one or more processes using the input, and provides an output. The input, output, and processes performed by various modules will be apparent to one skilled in the art based upon the present disclosure. The processor 220 as discussed herein may be a single processor, a plurality of processors, or combinations thereof, which may also include processors that may have one or more processor “cores.” Operations performed by the processor 220 or modules included therein may be performed as a sequential process and/or be performed in parallel, concurrently, and/or in a distributed environment. In some embodiments the order of operations may be rearranged without departing from the spirit of the disclosed subject matter. The processor 220 and the modules or engines included therein may be configured to execute program code or programmable logic to perform the functions discussed herein, such as may be stored in the memory 208 and/or a secondary memory 230, discussed in more detail below.

The processor 220 of the equipment device 102 may include a querying module 222. The querying module 222 may be configured to execute queries on databases to identify information. The querying module 222 may receive one or more data values or query strings, and may execute a query string based thereon on an indicated database, such as the caption buffer 210, to identify information stored therein. The querying module 222 may then output the identified information to an appropriate engine or module of the equipment device 102 as necessary. The querying module 222 may, for example, execute queries on the caption buffer 210 for management of the buffer, such as to insert new caption entries 212 and remove old caption entries 212. The querying module 222 may also execute queries on the caption buffer 210 to identify caption entries 212 for display on the display device 104 following the receipt of user instructions.

The processor 220 of the equipment device 102 may also include a caption module 224. The caption module 224 may be configured to manage the display of captions on the display device 104 in accordance with the functions discussed herein. For instance, the caption module 224 may be configured to activate or deactivate the display of closed captions on the display device, manage the display of active closed caption entries, replace active closed caption entries with earlier closed caption entries (e.g., identified via the querying module 222) or display earlier closed caption entries concurrently with active closed caption entries, modify the settings of earlier closed caption entries for distinguishing on the display device 104, etc.

In some embodiments, the equipment device 102 may also include a secondary memory 230. The secondary memory 230 may be another memory in addition to the memory 208 that may be used to store additional data for use in performing the functions of the equipment device 102 as discussed herein. In some embodiments, the secondary memory 230 may be a different format or may use a different data storage method and/or schema than the memory 208. The secondary memory 230 may be any suitable type of memory, and, in some instances, may include multiple types of memory. For instance, the secondary memory 230 may be comprised of a hard disk drive 232 and one or more interfaces 234, where the interfaces 234 are configured to transmit data to and receive data from one or more removable storage units 236. Removable storage units 236 may include, for example, floppy disks, compact discs, digital video discs, Blu-ray discs, removable hard drives, flash drives, universal serial bus drives, etc.

In some cases, the equipment device 102 may also include a display interface 238. The display interface may be configured to interface the equipment device 102 with one or more display devices 240, such as the display device 104. The display devices 240 may be devices configured to display data received from the equipment device 102. Display devices 240 may be any suitable type of display, including, for example, liquid crystal displays, light emitting diode displays, thin film transistor display, capacitive touch displays, etc. In some instances, the equipment device 102 may include one or more display interfaces 238, which may interface with one or more display devices 240. Display devices 240 may, for example, display the video signal received by the equipment device 102 and, if activated, display the associated closed caption entries. The display devices 240 may also be configured to display earlier closed caption entries based on instructions submitted to the equipment device 102 by the user 108 without interrupting display of the video signal.

The equipment device 102 may also include an input/output interface 242. The input/output interface 242 may be configured to interface the equipment device 102 with one or more input devices 244 and/or output devices 246 for the transmission to and receipt of data from the respective devices. The input/output interface 242 may include any suitable type of interface, and in some instances may include multiple types of interfaces, such as for interfacing with multiple types of input devices 244 and/or output devices 246. Input devices 244 may include any suitable type of device for inputting data to an equipment device 102, such as a keyboard, mouse, microphone, camera, touch screen, click wheel, scroll wheel, remote control, etc. Input devices 244 may be configured to receive input from a user of the equipment device 102, such as the user 108, which may include an instruction submitted to view earlier closed caption entries. Additional instructions that may be received via the input device 244 include instructions to navigate forward and backward through earlier closed caption entries, cancel the display of earlier closed caption entries, and manage the settings for display of earlier closed caption entries. Output devices 246 may include any suitable type of device for outputting data from an equipment device 102, such as a speaker, remote control, headset, tactile feedback device, etc.

### Process for Display of Earlier Closed Caption Entries

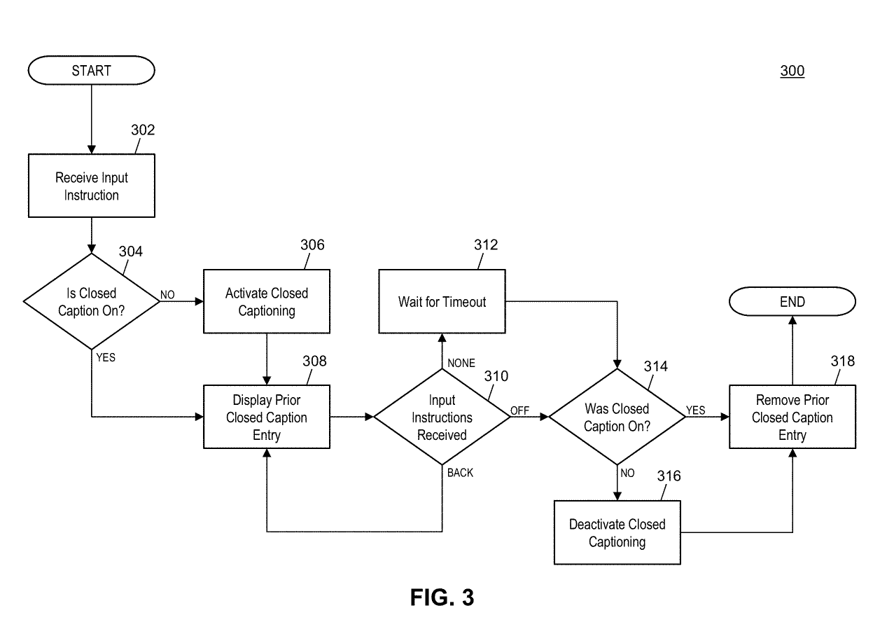

FIG. 3 illustrates a process 300 for the display of closed caption entries corresponding to earlier displayed portions of a video signal that are displayed following submission of a user instruction without interruption of the accompanying video signal.

In step 302, the input/output interface 242 of the equipment device 102 may receive a user instruction input by the user 108 via the input device 110. The user instruction may request the review of an earlier closed caption entry that is not directly associated with the portion of video signal being displayed on the display device 104 or by the equipment device 102 (e.g., via the display interface 238). In step 304, the caption module 224 of the processor 220 of the equipment device 102 may determine if closed captioning is already active on the display device 104, such as in instances where the closed captioning may be required to be active in order to display earlier closed caption entries. The determination may be based on the receipt of a notification following a prompt transmitted to the display device 104 (e.g., via the display interface 238) or based on data stored in the memory 208 of the equipment device 102 by the caption module 224, such as may indicate the status of the closed captioning service on the display device 104.

If closed captioning is not active, then, in step 306, the caption module 224 may generate an instruction to be electronically transmitted to the display device 104 via the communications interface 204 and/or display interface 238 to activate closed captioning on the display device 104. Once the closed captioning is active, or if the closed captioning was determined to already be active in step 304, then, in step 308, the querying module 222 of the processor 220 of the equipment device 102 may execute a query on the caption buffer 210 in the memory 208 to identify the most recently added caption entry 212, which may be electronically transmitted to the display device 104 for display thereon.

In step 310, the processor 220 of the equipment device 102 may determine what, if any, further input instructions are received from the user 108 via the input/output interface 242. If an instruction is received to navigate to earlier closed caption entries, then the process 300 may return to step 308 where the querying module 222 may identify the caption entry 212 prior to the currently displayed caption entry 212 in the caption buffer 210 for transmission to, and display on, the display device 104. If, in step 310, no new instructions are received, then, in step 312, the equipment device 102 may wait a predetermined amount of time for the display of the earlier closed caption entries to timeout. The predetermined amount of time may be stored in the memory 208 of the equipment device 102, and, in some instances, may be customized by the user 108. Once the timeout has expired, or if, in step 310, an instruction is received from the user 108 to turn off the earlier closed caption entries, then the process 300 may proceed to step 314.

In step 314, the caption module 224 may determine if closed caption had been previously activated by the display device 102 prior to the process 300 being executed, such as was determined in step 304. If the closed captioning was not active prior to the display of the earlier closed caption entry 212, then, in step 316, the caption module 224 may generate and submit an instruction to the display device 104 to deactivate closed captioning. Once the instruction is submitted, or if the closed captioning was previously activate, then, in step 318, the caption module 224 may generate and issue an instruction to the display device 104 to remove the display of the earlier closed caption entry 212 currently being displayed. The process 300 may then be completed, where the display device 104 may continue to operate as prior to the process 300. For instance, if the closed captioning is still active, the display device 104 may return to displaying the active closed caption entry associated with the portion of the video signal currently being displayed.

### Storage and Display of Closed Caption Entries

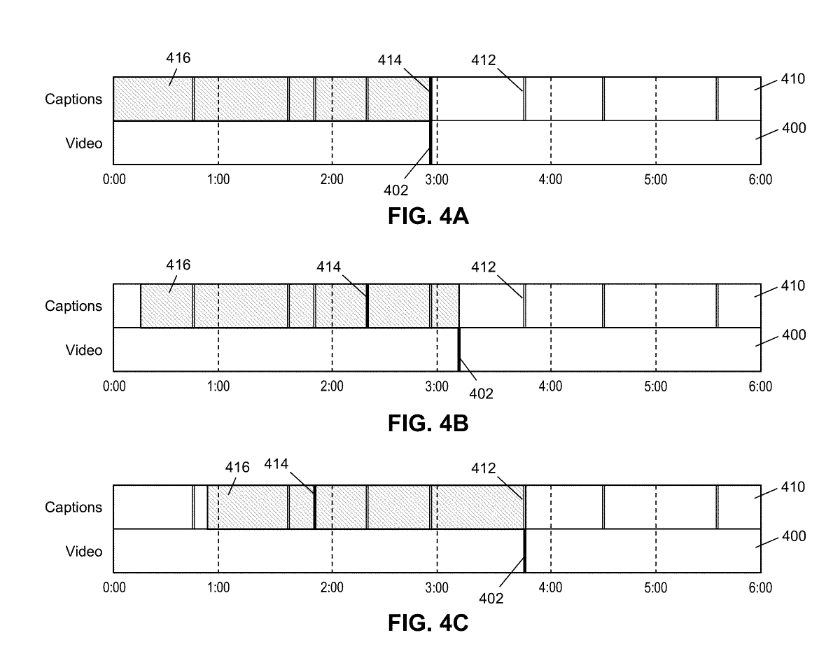

FIGS. 4A-4C illustrate the storage and display of closed caption entries in the equipment device 102 for display via the display device 104, where earlier closed caption entries may be displayed without interruption to the corresponding video signal.

As discussed above, the equipment device 102 may receive a source signal (e.g., via the communication medium 106) that is comprised of at least a video signal 400 and a closed caption signal 410. The video signal 400 may include video data to be displayed on the display device 104. As illustrated in FIG. 4A, the video data currently being displayed on the display device 104 may be based on a current timestamp 402 of the video. The closed caption signal 410 may be comprised of a plurality of closed caption entries 412. Each closed caption entry 412 may include text or other data to be displayed concurrently with video data, and may be associated with a specific portion of video data such that, traditionally, the included caption text or other data is displayed when the associated portion of video data is displayed. As illustrated in FIG. 4A, the caption 414 may be displayed concurrently with the video data at the current timestamp 402 due to its association with that portion of the video signal 400.

As discussed above, the equipment device 102 may also include a buffer 416. The buffer 416 may be stored in the memory 208 of the equipment device 102 and configured to store earlier (e.g., based on the current timestamp 402) closed caption entries 412 for later display. In the illustrated example, the buffer 416 is configured to store three minutes worth of closed caption entries 412. In the example illustrated in FIG. 4A, the buffer 416 includes five closed caption entries 412, which are the first five closed caption entries 412 including the caption 414, up to the current timestamp 402.

As also discussed above, the user 108 may be configured to instruct the equipment device 102 to display an earlier closed caption entry 412 without interrupting the display of video data from the video signal 400. In such instances, the user 108 may use the input device 110 to instruct the equipment device 102 to display an earlier closed caption entry 412. In the example illustrated in FIG. 4B, the user 108 instructs the equipment device 102 to return to the caption prior to the most recent closed caption entry (e.g., previously the caption 414) to be displayed. The equipment device 102 may display the corresponding caption 414 to the user 108 (e.g., via the display device 104). As illustrated, the caption 414 may be associated with an earlier portion of the video signal 400 than currently displayed as indicated via the current timestamp 402. As also illustrated in FIG. 4B, the buffer 416 may continue to store the same closed caption entries 412 due to no changes in the closed caption entries 412 in the three minutes preceding the current timestamp 402.

When reviewing earlier closed caption entries 412, the user 108 may continue to “scroll” back through prior closed caption entries. In the example illustrated in FIG. 4C, the user 108 may scroll to the next earlier closed caption entry, which may become the displayed caption 414. In doing so, the user 108 may miss the closed caption entry 212 that is associated with the currently displayed video data, indicated via the current timestamp 402. However, as the buffer 416 has progressed along with the current timestamp 402, the buffer 416 may discard the earliest closed caption entry 412 stored therein, and store the closed caption entry 412 associated with the currently displayed video data (e.g., following first in, first out methodology). As a result, the user 108 may be free to proceed back through each closed caption entry 412 to view the one that is currently being missed. In some instances, the equipment device 102 may automatically display the closed caption entry 412 being missed after a predetermined of time without instruction from the user 108.

### Exemplary Method for Temporary Display of Closed Captions

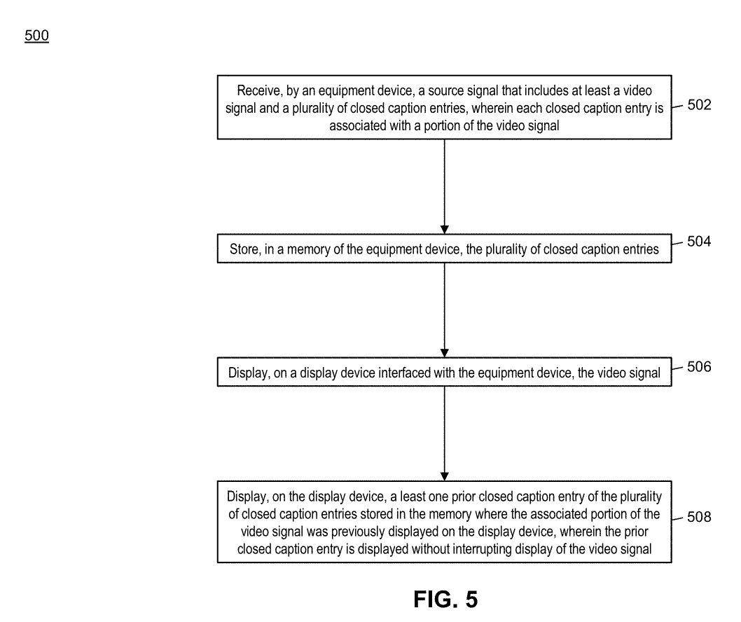

FIG. 5 illustrates a method 500 for the temporary display of closed captions associated with earlier displayed portions of a video signal that are displayed without interruption of the accompanying video signal.

In step 502, a source signal may be received by an equipment device (e.g., the equipment device 102) that includes at least a video signal and a plurality of closed caption entries, wherein each closed caption entry is associated with a portion of the video signal. In step 504, the plurality of closed caption entries (e.g., closed caption entries 212) may be stored in a memory (e.g., the caption buffer 210 of the memory 208) of the equipment device.

In step 506, the video signal may be displayed on a display device (e.g., the display device 104) interfaced with (e.g., via the display interface 238) the equipment device. In step 508, at least one prior closed caption entry of the plurality of closed caption entries stored in the memory may be displayed on the display device where the associated portion of the video signal was previously displayed on the display device, and wherein the prior closed caption entry is displayed without interrupting the display of the video signal.

In one embodiment, the method 500 may further include receiving, via an input interface (e.g., the input/output interface 242) of the equipment device, an instruction requesting display of the at least one prior closed caption entry prior to display of the at least one prior closed caption entry. In some embodiments, the method 400 may also include displaying, on the display device, a current closed caption entry of the plurality of closed caption entries where the associated portion of the video signal corresponds to the video signal being displayed, wherein display of the at least one prior closed caption entry displaces or replaces the current closed caption entry.

In one embodiment, the method 500 may further include displaying, on the display device, a current closed caption entry of the plurality of closed caption entries where the associated portion of the video signal corresponds to the video signal being displayed, wherein the at least one prior closed caption entry is displayed concurrently with the current closed caption entry. In a further embodiment, the at least one prior closed caption entry may be distinguished from the current closed caption entry by at least one of: font face, font size, font color, screen position, font style, and font effect.

In some embodiments, the source signal may further include a timestamp associated with each of the plurality of closed caption entries, and display of the at least one prior closed caption entry may further include display of the associated timestamp. In a further embodiment, the displayed timestamp may indicate a difference in time between the associated portion of the video signal and a portion of the video signal displayed at time of the display of the at least one prior closed caption entry.

Techniques consistent with the present disclosure provide, among other features, systems and methods for temporary display of closed captions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for temporary display of closed captions, comprising:
receiving, by an equipment device, a source signal that includes at least a video signal and a plurality of closed caption entries, wherein each closed caption entry is associated with a portion of the video signal;
storing, in a memory of the equipment device, the plurality of closed caption entries;
displaying, on a display device interfaced with the equipment device, the video signal; and
displaying, on the display device, a least one prior closed caption entry of the plurality of closed caption entries stored in the memory where the associated portion of the video signal was previously displayed on the display device, wherein
the prior closed caption entry is displayed without interrupting display of the video signal, and
the prior closed caption entry which is displayed is provided based on an instruction to scroll through a plurality of prior closed caption entry which are associated with a plurality of earlier portions of the video signal.

2. The method of claim 1, further comprising:
receiving, via an input interface of the equipment device, an instruction requesting display of the at least one prior closed caption entry prior to display of the at least one prior closed caption entry.

3. The method of claim 1, further comprising:
displaying, on the display device, a current closed caption entry of the plurality of closed caption entries where the associated portion of the video signal corresponds to the video signal being displayed, wherein
display of the at least one prior closed caption entry displaces or replaces the current closed caption entry.

4. The method of claim 1, further comprising:
displaying, on the display device, a current closed caption entry of the plurality of closed caption entries where the associated portion of the video signal corresponds to the video signal being displayed, wherein
the at least one prior closed caption entry is displayed concurrently with the current closed caption entry.

5. The method of claim 4, wherein the at least one prior closed caption entry is distinguished from the current closed caption entry by at least one of: font face, font size, font color, screen position, font style, and font effect.

6. The method of claim 1, wherein
the source signal further includes a timestamp associated with each of the plurality of closed caption entries, and
display of the at least one prior closed caption entry further includes display of the associated timestamp.

7. The method of claim 6, wherein the displayed timestamp indicates a difference in time between the associated portion of the video signal and a portion of the video signal displayed at time of the display of the at least one prior closed caption entry.

8. A system for temporary display of closed captions, comprising:
a communications interface of an equipment device configured to receive a source signal that includes at least a video signal and a plurality of closed caption entries, wherein each closed caption entry is associated with a portion of the video signal;
a memory of the equipment device configured to receive the plurality of closed caption entries; and
a display device interfaced with the equipment device configured to display the video signal, and
at least one prior closed caption entry of the plurality of closed caption entries stored in the memory where the associated portion of the video signal was previously displayed on the display device, wherein
the prior closed caption entry is displayed without interrupting display of the video signal, and
the prior closed caption entry which is displayed is provided based on an instruction to scroll through a plurality of prior closed caption entry which are associated with a plurality of earlier portions of the video signal.

9. The system of claim 8, further comprising:
an input interface of the equipment device configured to receive an instruction requesting display of the at least one prior closed caption entry prior to display of the at least one prior closed caption entry.

10. The system of claim 8, wherein
the display device is further configured to display a current closed caption entry of the plurality of closed caption entries where the associated portion of the video signal corresponds to the video signal being displayed, and
display of the at least one prior closed caption entry displaces or replaces the current closed caption entry.

11. The system of claim 8, wherein
the display device is further configured to display a current closed caption entry of the plurality of closed caption entries where the associated portion of the video signal corresponds to the video signal being displayed, and
the at least one prior closed caption entry is displayed concurrently with the current closed caption entry.

12. The system of claim 11, wherein the at least one prior closed caption entry is distinguished from the current closed caption entry by at least one of: font face, font size, font color, screen position, font style, and font effect.

13. The system of claim 8, wherein
the source signal further includes a timestamp associated with each of the plurality of closed caption entries, and
display of the at least one prior closed caption entry further includes display of the associated timestamp.

14. The system of claim 13, wherein the displayed timestamp indicates a difference in time between the associated portion of the video signal and a portion of the video signal displayed at time of the display of the at least one prior closed caption entry.

15. A non-transitory computer readable media having instructions operable to cause one or more processors to perform the operations comprising:
receiving, by an equipment device, a source signal that includes at least a video signal and a plurality of closed caption entries, wherein each closed caption entry is associated with a portion of the video signal;
storing, in a memory of the equipment device, the plurality of closed caption entries;
displaying, on a display device interfaced with the equipment device, the video signal; and
displaying, on the display device, a least one prior closed caption entry of the plurality of closed caption entries stored in the memory where the associated portion of the video signal was previously displayed on the display device, wherein
the prior closed caption entry is displayed without interrupting display of the video signal, and
the prior closed caption entry which is displayed is provided based on an instruction to scroll through a plurality of prior closed caption entry which are associated with a plurality of earlier portions of the video signal.

16. The non-transitory computer readable media of claim 15, being further configured to perform the operations comprising:
receiving, via an input interface of the equipment device, an instruction requesting display of the at least one prior closed caption entry prior to display of the at least one prior closed caption entry.

17. The non-transitory computer readable media of claim 15, being further configured to perform the operations comprising:
displaying, on the display device, a current closed caption entry of the plurality of closed caption entries where the associated portion of the video signal corresponds to the video signal being displayed, wherein
display of the at least one prior closed caption entry displaces or replaces the current closed caption entry.

18. The non-transitory computer readable media of claim 15, being further configured to perform the operations comprising:
displaying, on the display device, a current closed caption entry of the plurality of closed caption entries where the associated portion of the video signal corresponds to the video signal being displayed, wherein
the at least one prior closed caption entry is displayed concurrently with the current closed caption entry.

19. The non-transitory computer readable media of claim 15, wherein
the source signal further includes a timestamp associated with each of the plurality of closed caption entries, and
display of the at least one prior closed caption entry further includes display of the associated timestamp.

20. The non-transitory computer readable media of claim 19, wherein the displayed timestamp indicates a difference in time between the associated portion of the video signal and a portion of the video signal displayed at time of the display of the at least one prior closed caption entry.
